(19) United States
(12) Patent Application Publication
(10) Pub. No.: US 2025/0144655 A1
(43) Pub. Date: May 8, 2025

(54) MOLD FOR APPLYING A LIQUID ONTO A PLASMA-BASED OR CRYOPRECIPITATE-BASED FILM AND METHOD FOR COATING A PLASMA-BASED OR CRYOPRECIPITATE-BASED FILM

(71) Applicant: OCTAPHARMA AG, Lachen (CH)

(72) Inventors: Dominik STAUBER, Wien (AT); Klaus TSCHETSCHKOWITSCH, Wien (AT)

(21) Appl. No.: 18/837,553

(22) PCT Filed: Mar. 8, 2023
(86) PCT No.: PCT/EP2023/055915

§ 371 Date: Aug. 9, 2024

(30) Foreign Application Priority Data
Mar. 9, 2022 (EP) 22161119.7

(51) Int. Cl. B05B 13/02; B05B 12/20; B05C 3/18; B05C 13/02

(52) U.S. Cl. CPC B05B 13/0285; B05C 13/02; B05B 12/20; B05C 3/18

(57) ABSTRACT

Mold for applying a liquid onto a plasma-based or cryoprecipitate-based film comprising at least one frame (1) configured for carrying said plasma-based or cryoprecipitate-based film, at least one base plate (2) and at least one mold body (3) with at least one passage (10), wherein said frame (1) is arranged between said base plate (2) and said mold body (3) such that said liquid can be applied, preferably poured or sprayed, onto said plasma-based or cryoprecipitate-based film through said passage (10). Further, a method for coating a plasma-based or cryoprecipitate-based film is described.

The present invention relates to a mold for applying a liquid onto a plasma-based or cryoprecipitate-based film.

The present invention further relates to a method for coating a plasma-based or cryoprecipitate-based film.

Any discussion of the background art throughout the specification should in no way be considered as an admission that such art is widely known or forms part of common general knowledge in the field.

Films or sheets for use as medical devices or products often contain embedded material such as fibers or fabrics to alter/improve the mechanical properties of such films or sheets, in particular to improve their resistance to pressure. However, depending on the kind of fibers and/or fabrics used, such enforced films or sheets are known to trigger complications in situ due to only partial biodegradability of the fibers and fabrics. Typical complications arising include the development of connective tissue between otherwise unrelated tissues and/or organs leading to post-surgical/surgery-induced adhesions.

Post-surgical/surgery-induced adhesions can lead to severe clinical complications such as loss of sensation, infertility, intestinal blockage and pelvic pain. The severity of the symptoms depends on the location and size of the adhesion. The number of patients suffering from post-surgical/surgery-induced adhesions is increasing and 55%-90% of patients that undergo gynaecological and/or abdominal surgeries face complications arising from adhesions.

Entirely biodegradable fibrin films are known and plasma-based films have been described, for example see EP 0485210 A2 and U.S. Pat. No. 8,529,959 B2. As already indicated above, plasma-based, topical or implantable medical devices or products such as films or sheets generally have a biocompatibility advantage in comparison to similar films or sheets comprising non-plasma based materials such as fibers and/or fabrics. In addition to the complications described above, plasma-based devices or products such as films are suitable to provide individual patients with an implantable, plasma-based device or product generated from their own plasma providing a very high degree of biocompatibility.

EP 0485210 A2 discloses a manufacturing method for blood plasma-based films comprising the clotting of 50 ml citrated plasma with 8-10 NIH units of thrombin in a mold apparatus. However, the blood plasma-based films prepared in accordance with the disclosure of EP 0485210 A2 are brittle, and therefore inflexible, and display only poor mechanical strength such that the films break upon folding, making them unsuitable for applications where flexibility and/or pressure resistance is required.

U.S. Pat. No. 8,529,959 B2 discloses sheets comprising a blood plasma-derived plastic. The blood plasma-derived plastic is described as being obtained by clotting of blood with calcium, drying the obtained clot and grinding of the dried clot to produce plasma clot powder, which is mixed with glycerol to prepare a dough comprising 65% plasma clot powder and 35% glycerol, and wherein the dough is subsequently pressure-molded at an elevated temperature and high pressure to form the sheets. The sheets prepared in accordance with the disclosure of U.S. Pat. No. 8,529,959 B2 have a very limited flexibility and poor mechanical strength such that the sheets break upon folding making them unsuitable for applications where flexibility and or pressure resistance is required.

WO 2017/210267 A2 discloses flexible plasma-based films useful as a haemostat in the treatment and/or prevention of mild to severe as well as arterial bleedings, as an anti-adhesive sheet to reduce or prevent development of surgery-induced adhesions, as a wound healing patch, as a wound dressing, or as a film useful in hernia repair.

Often it is desirable to provide a coating onto the film. For example, WO 2017/210267 A2 describes applying an agent by spay-coating, spray-drying, brushing and/or soaking onto the film. However, plasma-based films are often fragile and sometimes brittle and, as a result, are difficult to handle or manipulate. Therefore, it is regularly difficult to apply a liquid onto a plasma-based or cryoprecipitate-based film, especially, to achieve a uniform coating of only one side of the plasma-based or cryoprecipitate-based film by applying such a liquid.

Embodiments of the present invention therefore address the above problem by providing a mold and a method for applying a liquid onto a plasma-based or cryoprecipitate-based film such as to achieve a uniformly coated film.

In a first aspect, the present invention relates to a mold for applying a liquid onto a plasma-based or cryoprecipitate-based film comprising at least one frame configured for carrying said plasma-based or cryoprecipitate-based film, at least one base plate and at least one mold body with at least one passage, wherein said frame is arranged between said base plate and said mold body such that said liquid can be applied, preferably poured or sprayed, onto said plasma-based or cryoprecipitate-based film through said passage.

In a second aspect, the present invention relates to a method for coating a plasma-based or cryoprecipitate-based film by using a mold of the first aspect, comprising the following steps:
providing a frame carrying a plasma-based or cryoprecipitate-based film,
arranging said frame between a base plate and a mold body, preferably such that said plasma-based or cryoprecipitate-based film is arranged closer to the opening of the passage of said mold body than said frame,
applying, preferably pouring or spraying, a liquid onto said plasma-based or cryoprecipitate-based film.

Providing the plasma-based or cryoprecipitate-based film on a frame has the advantage that the plasma-based or cryoprecipitate-based film can be handled without the risk of damage. Further, the frame serves as an abutment when the film is arranged in the mold. When the frame carrying the film is positioned between the base plate and the mold body, liquid can be exclusively applied to one side of the film without any risk of applying liquid to the side that faces the base plate, i.e. the “wrong side” of the film. This ensures that anti-adhesive properties of the film suitable to prevent the development of trauma-or surgery-induced adhesions are maintained on the uncoated side of the film, while the coating may mediate the fixation of the film in situ, for example at a site of injury or trauma where the coated film/medical device is used as a haemostat, a wound healing patch a wound dressing or as a support in hernia repair. A further advantage is that the mold functions as a receptacle in which the plasma-based or cryoprecipitate-based film constitutes the bottom. Hence, when the mold is horizontally aligned, a uniform coating of one side of the film can be achieved by filling the receptacle with a predetermined amount of liquid and allowing the liquid to dry on top of the film.

According to a preferred embodiment, the plasma-based or cryoprecipitate-based film can be arranged between two frames. Further, it is possible that a supporting sheet is attached to one side of the plasma-based or cryoprecipitate-based film. If the plasma-based or cryoprecipitate-based film, optionally together with a supporting sheet, is arranged between two frames, one of the frames is detached for providing the frame carrying a plasma-based or cryoprecipitate-based film to be arranged between the base plate and the mold body of the mold of the first aspect or according to the method of the second aspect. Preferably, when a supporting sheet is present, the frame in direct contact with the plasma-based or cryoprecipitate-based film is detached (not the frame contacting the supporting sheet). In this case, the frame in direct contact with the supporting sheet (the supporting sheet being attached to the plasma-based or cryoprecipitate-based film) constitutes the frame configured to carry the plasma-based or cryoprecipitate-based film of the mold of the invention. A skilled person will understand, that a supporting sheet does not need to be present. Essential is that the frame is arranged in such a way in the mold of the present invention that the liquid can be applied, through the passage of the mould body, directly to the plasma-based film (but not to the supporting sheet).

In a preferred embodiment, said mold body comprises at least one frame positioning groove. An advantage of the frame positioning groove is that the frame together with the film can be easily arranged in the desired position within the mold body.

According to a further embodiment, at least one sealing gasket is provided between said frame and said mold body. By providing the sealing gasket the liquid applied will only get into contact with the part of the plasma-based or cryoprecipitate-based film that is to be coated.

In a preferred embodiment, said mold body comprises at least one gasket positioning groove. This has the advantage that the gasket is arranged on the mold body in a desired and predetermined position. Further, the gasket positioning groove can serve as a seating for the gasket. This allows the seal to be form-fitted to the mold body during operation but that, for example for cleaning, the gasket can be easily detached from and subsequently re-attached to the mold body.

According to a further embodiment, at least one fixation means is arranged for detachably connecting said mold body to said base plate. Hence, the mold can be disassembled for cleaning each component separately. Further, it is possible that the fixation means serve as a guide during the assembly of the mold components when the frame carrying the plasma-based or cryoprecipitate-based film is positioned on the base plate.

In a preferred embodiment, said passage comprises a depth of at least 3 cm, preferably at least 4 cm, more preferably at least 5 cm. This has the advantage that a column of liquid comprising a sufficient height can be applied onto the plasma-based or cryoprecipitate-based film, such that a coating will remain when the liquid has dried. Further, the depth of the passage allows for the serial application of several liquids to the same film such that, ultimately a multi-layered plasma-based or cryoprecipitate-based device is produced. Namely, a second liquid can be applied to a film already containing a first coat, wherein the first coat results from a first liquid having been applied and dried onto the film previously, which when died onto the coated film provides a second layer of coating on said film.

According to a further embodiment, said frame is configured for carrying a plasma-based or cryoprecipitate-based film having a circular shape, an oval shape, a rectangular shape or a square shape. The configuration of the frame can be chosen under consideration of the criteria of the product that can be produced from the coated plasma-based or cryoprecipitate-based film.

In a preferred embodiment, said fixation means comprises a threaded rod with a nut. An advantage of this design is that it is easy to manufacture and provides a secure fixation of the mold's components.

According to a further embodiment, wherein the film is a flexible plasma-based or cryoprecipitate-based film, preferably said film comprises more than 2.5 International Units (IU) of thrombin per ml of plasma or cryoprecipitate, such as between 2.5 and 10 IUs of thrombin per ml of plasma or cryoprecipitate, which has a thickness ranging from 0.005 to 0.1 mm, and is characterized by a burst pressure of 50 to 1000 mm Hg. Films with such characteristics are particularly suited for use as haemostats to stop mild to severe and even arterial bleeding, as anti-adhesion barriers, wound healing patches, wound dressings or as supports for hernia repair due to their high degree of flexibility while maintaining the required tensile strength and pressure resistance required for such applications. As stated above, using such films in the methods of the present invention ensures that the advantageous surface properties of said films is maintained on at least one side of the multi-layered device that may be produced, while the multilayer coating may mediate fixation of the device at a site of trauma or injury.

In a preferred embodiment, said flexible plasma-based or cryoprecipitate-based film is coated with a water-activated cross-linking agent, preferably with 2,2′-Oxydiacetic acid bis-N-succinimidyl ester (alternative denominations: bis-N-succinimidyl diglycolic acid; DIG(NHS)₂; CAS-No 373614-12-1). This first DIG(NHS)₂-coat may be applied in a mold of the first aspect and according to the method of the second aspect of the invention as a primer layer for a second, water-based coating, as the water content triggers the DIG(NHS)₂'s cross-linking activity allowing for components of the second coat to be covalently bound to the plasma-based or cryoprecipitate-based film.

As such, according to a further embodiment, said liquid applied to said DIG(NHS)₂-coated, plasma-based or cryoprecipitate-based film comprises water, fibrinogen and carboxymethyl cellulose (CMC). The use of such a liquid has the advantage, as already indicated, the cross-linking activity of DIG(NHS)₂ is activated such that fibrinogen is covalently bound to the plasma-based or cryoprecipitate-based film and, once dried, the CMC is thought to be deposited on top of the fibrinogen facing away from the plasma-based or cryoprecipitate-based film. Therefore—without wanting to be bound by theory—CMC may provide a certain degree of separation of the fibrinogen from a further coat being applied.

For example, a third water-free liquid comprising thrombin can be applied using the mold and according to the method of the present invention to produce a multi-layered medical device. Such a multi-layered medical device is suitable for use in a number of in situ applications. In particular, such devices are highly advantageous when used as haemostats to stop mild to severe and even arterial bleeding, as wound healing patches, as wound dressings or as supports for hernia repair, because the uncoated film surface still provides desirable anti-adhesion properties while, once placed at a site of trauma or injury, i.e. once placed in situ, the coating layers will securely fix the device at this particular site. This is because in situ, the coating layers are again exposed to water, allowing for thrombin to convert the fibrinogen into fibrin, which in turn—while still covalently linked to the film—acts as an adhesive securely fixing the device to the specific site of trauma or injury.

In a preferred embodiment, said frame comprises at least two frame elements each comprising a separate plasma-based or cryoprecipitate-based film. Hence, the number and the size of the plasma-based or cryoprecipitate-based films can be chosen under consideration of the production process and the features of the medical device or product ultimately to be produced with the plasma-based or cryoprecipitate-based film.

According to a further embodiment, said mold body comprises at least two passages corresponding with said at least two frame elements such that when said base plate, said frame and said mold body are assembled to form said mold, liquid can be poured through each of said passages onto each respective film. This allows to provide several plasma-based or cryoprecipitate-based films with a coating. Further, it is possible that the coating of the respective plasma-based or cryoprecipitate-based films differ from each other, for example with regard to the components of the liquid and/or the amount of liquid being used to coat the plasma-based or cryoprecipitate-based films.

In a preferred embodiment, said base plate and/or said frame is/are made from metal, preferably from stainless steel. An advantage of this material is that it is robust and easy to clean.

According to a further embodiment, wherein said mold body is made from plastic, preferably from Polyoxymethylene. An advantage of plastic, especially of Polyoxymethylene, is that it can be easily processed. Further, the plasma-based or cryoprecipitate-based film does not stick to these materials when the mold body is detached from the plasma-based or cryoprecipitate-based film being carried by the frame. Hence, the likelihood of damage to a typically fragile plasma-based or cryoprecipitate-based film is reduced.

In a further embodiment said frame is configured to carry said plasma-based or cryoprecipitate-based film and a supporting sheet, preferably, wherein said frame is in contact with said plasma-based or cryoprecipitate-based film. Providing a supporting sheet has the advantage, that the fragile plasma-based or cryoprecipitate-based film can be handled easier without causing any damage.

Embodiments of the invention will now be described, by way of example only, with reference to the accompanying drawings in which:

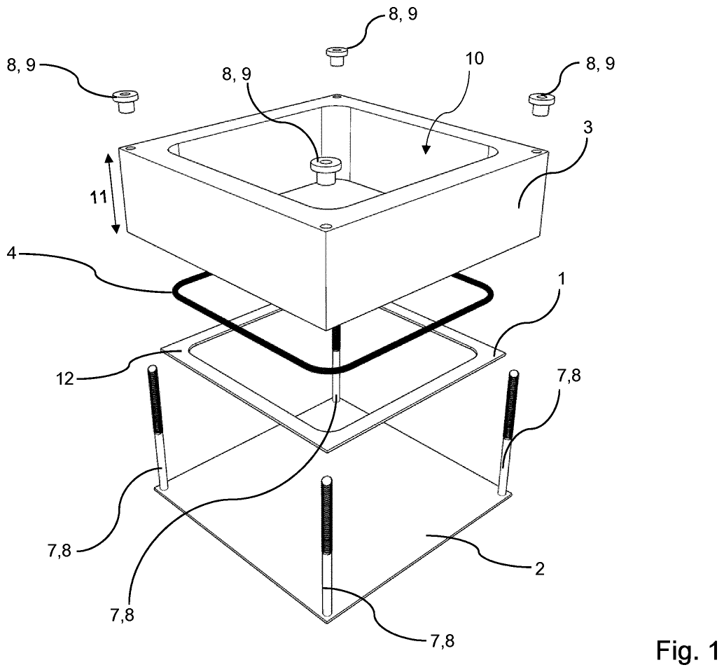

FIG. 1 schematically shows a top-down exploded-view drawing of a mold according to an embodiment of the present invention, and

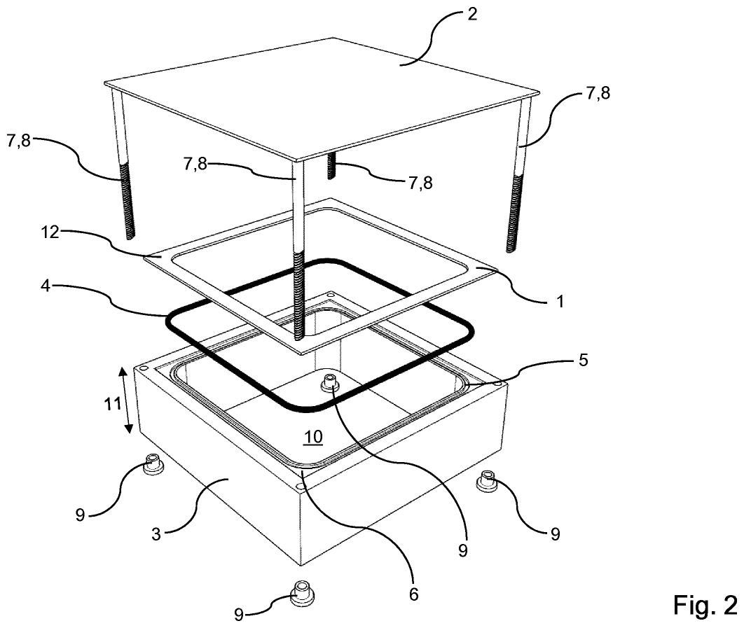

FIG. 2 schematically shows a bottom-up exploded-view drawing of the mold according to FIG. 1.

FIGS. 1 and 2 show an embodiment of a mold, which can be used in the method for coating a plasma-based or cryoprecipitate-based film.

The mold comprises a frame 1 configured for carrying a plasma-based or cryoprecipitate-based film (not shown), a base plate 2 and a mold body 3. FIG. 2 shows a sealing gasket 4 being arranged in a sealing gasket positioning groove 5 of the mold body 3. Furthermore, the mold body 3 comprises a frame positioning groove 6 such that the frame 1 can be kept in a predetermined position.

The plasma-based or cryoprecipitate-based film can initially be arranged on a frame 1 or between two frames 1, optionally together with a support sheet on one side of the plasma-based or cryoprecipitate-based film. Preferably, when a supporting sheet is present, the frame 1 in direct contact with the plasma-based or cryoprecipitate-based film is detached (not the frame 1 contacting the supporting sheet). In this case, the frame 1 in direct contact with the supporting sheet (the supporting sheet being attached to the plasma-based or cryoprecipitate-based film) constitutes the frame configured to carry the plasma-based or cryoprecipitate-based film of the mold of the invention.

Then, the frame 1 is arranged between the base plate 2 and the mold body 3, preferably in such a way that the frame 1 is in direct contact with the base plate 2 and the plasma-based or cryoprecipitate-based film is in contact with the gasket 4 and/or the mold body 3. When the frame 1 is positioned in the frame positioning groove 6 of the mold body 3, the mold body 3 and the base plate 2 are attached to each other with fixation means 7. In this embodiment, the fixation means 7 comprise threaded rods 8 with nuts 9.

The liquid can then be applied onto the plasma-based or cryoprecipitate-based film through the passage 10 of the mold body 3. The passage 10 comprises a depth 11 of at least 3 cm, such that a predetermined amount of liquid can be applied. After the liquid is dried, a coating will remain on the plasma-based or cryoprecipitate-based film. Once the first coating has dried this process can be repeated to produce a multi-layered medical device comprising a plasma-based or cryoprecipitate-based film surface on one side and multiple layers of coating on the other.

Then, the mold body 3 can be detached from the base plate 2 by unscrewing the nuts 9 and the coated plasma-based or cryoprecipitate-based film carried by the frame 1 can be further processed.

In the described embodiment, the frame 1 comprises a square shape. A skilled person will understand that other shapes are possible. Further, the frame 1 shown in the embodiment comprises a single frame element 12. It is possible, that the frame 1 comprises more than one frame element 12 each comprising a separate plasma-based or cryoprecipitate-based film. In this case, the mold body 3 should comprise a corresponding number of passages 10 such that, when the base plate 2, the frame 1 and the mold body are assembled to form the mold, liquid can be poured through each of the passages 10 onto each respective plasma-based or cryoprecipitate-based film.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### LIST OF REFERENCE SIGNS

2 base plate
3 mold body
4 gasket
5 gasket positioning groove
6 frame positioning groove
7 fixation means
8 threaded rod
9 nut

1. A mold for applying a liquid onto a plasma-based or cryoprecipitate-based film comprising:
at least one frame configured for carrying said plasma-based or cryoprecipitate-based film;
at least one base plate; and
at least one mold body with at least one passage, wherein said frame is arranged between said base plate and said at least one mold body such that said liquid can be applied onto said plasma-based or cryoprecipitate-based film through said at least one passage.

2. The mold of claim 1, wherein said at least one mold body comprises at least one frame positioning groove.

3. The mold of claim 1 further comprising at least one sealing gasket provided between said at least one frame and said at least one mold body.

4. The mold of claim 1, wherein said at least one mold body comprises at least one gasket positioning groove.

5. The mold of claim 1 further comprising at least one fixation means is arranged for detachably connecting said at least one mold body to said at least one base plate.

6. The mold of claim 1, wherein said at least one passage comprises a depth of at least 3 cm, at least 4 cm, or at least 5 cm.

7. The mold of claim 1, wherein said at least one frame is configured for carrying a plasma-based or cryoprecipitate-based film having a circular shape, an oval shape, a rectangular shape, or a square shape.

8. The mold of claim 5, wherein said at least one fixation means comprises a threaded rod with a nut.

9. The mold of claim 1 wherein said plasma-based or cryoprecipitate-based film is a flexible plasma-based or cryoprecipitate-based film.

10. The mold of to claim 9, wherein said flexible plasma-based or cryoprecipitate-based film comprises a coat of a water-activated cross-linking agent.

11. The mold of claim 10, wherein said liquid comprises water, fibrinogen, and carboxymethyl cellulose (CMC).

12. The mold of claim 1, wherein said at least one frame comprises at least two frame elements, each frame element carrying a plasma-based or cryoprecipitate-based film.

13. The mold of to claim 12, wherein said at least one mold body comprises at least two passages corresponding with said at least two frame elements such that when said at least one base plate, said at least one frame, and said at least one mold body are assembled to form said mold, the liquid can be poured through each of said at least two passages onto each respective plasma-based or cryoprecipitate-based film.

14. The mold of claim 1, wherein said at least one base plate and/or said at least one frame is/are made from metal.

15. The mold of claim 1, wherein said at least one mold body is made from plastic.

16. The mold of claim 1, wherein said at least one frame is configured to carry said plasma-based or cryoprecipitate-based film and a supporting sheet.

17. A method for coating a plasma-based or cryoprecipitate-based film with a liquid, comprising the following steps:
providing a frame carrying a plasma-based or cryoprecipitate-based film;
arranging said frame between a base plate and a mold body comprising a passage; and,
applying said liquid onto said plasma-based or cryoprecipitate-based film through said passage.

18. The method of claim 17, wherein:
arranging said frame further comprises arranging said frame such that said plasma-based or cryoprecipitate-based film is arranged closer to an opening of the passage of said mold body than said frame; and
applying said liquid comprises pouring or spraying said liquid onto said plasma-based or cryoprecipitate-based film through said passage.

19. The mold of claim 9, wherein said flexible plasma-based or cryoprecipitate-based film is characterized by having more than 2.5 International Units (IU) of thrombin per ml of plasma, a thickness ranging from 0.005 to 0.1 mm, and a burst pressure of 50 to 1000 mm Hg.

20. The mold of claim 10, wherein the water-activated cross-linking agent is 2,2′-Oxydiacetic acid bis-N-succinimidyl ester (DIG(NHS)₂).
